(19) United States
(12) Patent Application Publication
(10) Pub. No.: US 2008/0217899 A1
(43) Pub. Date: Sep. 11, 2008

(54) Vehicle Attachment for Folding a Ground Cover

(76) Inventor: Mathew King, Auckland (NZ)

Correspondence Address: DANN, DORFMAN, HERRELL & SKILLMAN, 1601 MARKET STREET, SUITE 2400, PHILADELPHIA, PA, 19103-2307, US

(21) Appl. No.: 10/590,338

(22) PCT Filed: Feb. 28, 2005
(86) PCT No.: PCT/NZ05/00032

§ 371 Date: Jun. 25, 2007

(30) Foreign Application Priority Data
Feb. 26, 2004 (NZ) 531396

(51) Int. Cl. B60R 11/00

(52) U.S. Cl. 280/769

(57) ABSTRACT

A ground cover removal attachment for a vehicle such as a quad bike, for moving a sheet ground cover while on the ground, in an orchard for example, comprises an arm (2) with a connection (10) at one end of the arm (2) for mounting the arm (2) to a vehicle so that the arm (2) extends outwardly of one side of the vehicle, and an outer end of the arm (2) shaped (14, 15, 16, 17) to engage the ground cover on one side of the ground cover to move the ground cover to the side of the vehicle as the vehicle moves alongside the ground cover.

### FIELD OF INVENTION

The invention relates to a ground cover removal attachment for a vehicle such as a quad bike, for use in an orchard for example to remove to one side a sheet ground cover.

### BACKGROUND OF INVENTION

To promote plant growth and development a sheet ground cover may be placed over the ground adjacent or near to the plant(s) to conserve soil moisture, control weed growth, and/or reflect light back upwards to the plant. The ground covers are commonly used within orchard blocks which generally comprise rows of crops, plants, trees or vines. For such applications, the ground covers are generally installed between adjacent rows and are available in various lengths and widths to suit.

Generally such ground covers are put down and removed at various times during the year. They can be used consecutively on several crops within a growing season and reused over subsequent seasons. Also, during the growing season, in some cases the ground cover needs to be temporarily removed to be later replaced, for example to allow soil heat to move from the soil to the air above, or so that the ground cover is not damaged by the traffic of workers walking on it during harvest picks of the crop. Pushing the cover to one side is the best way to do this quickly. Moving the ground covers is time consuming and labour intensive, especially in large orchards.

### SUMMARY OF INVENTION

In broad terms in one aspect the invention comprises a ground cover removal attachment for a vehicle for moving a sheet ground cover while on the ground, comprising an arm with a connection at one end of the arm for maintaining the arm to a vehicle so that the arm extends outwardly of one side of the vehicle, and an outer end of the arm shaped to engage the ground cover on one side of the ground cover to move the ground cover to the side of the vehicle as the vehicle moves alongside the ground cover.

Preferably the shaped outer end of the attachment comprises one part adapted to move beneath a side margin of the ground cover and another part adapted to contact a side edge of the ground cover, as the vehicle moves alongside the ground cover, and the part adapted to move beneath the side margin of the ground cover has a lateral dimension in a direction generally away from the arm which is greater than a height dimension of the part adapted to contact a side edge of the ground cover. A further part of the shaped end of the arm may extend from the side edge contacting part in a direction generally away from the arm.

The invention may also be said to comprise a ground cover removal arm for moving a ground cover with a vehicle to which the arm is attached with the arm extending outwardly of one side of the vehicle, the arm including at one end a coupling for mounting the arm to a vehicle, an outer end formed as a fork for lifting and folding a side of the ground cover as the vehicle moves alongside the ground cover to one side of the ground cover, and a brace member adapted to extend between the arm and the vehicle at a spaced mounting point to the vehicle.

The invention also includes a vehicle with an arm extending outwardly of the vehicle to one side thereof beyond that side of the vehicle, and capable of lifting and folding a side of a sheet ground cover to one side as the vehicle moves alongside the ground cover, the arm having spaced outwardly of the side of the vehicle an operative part for lifting and moving the ground cover.

To those skilled in the art to which the invention relates, many changes in construction and widely differing embodiments and applications of the invention will suggest themselves without departing from the scope of the invention as defined in the appended claims. The disclosures and the descriptions herein are purely illustrative and are not intended to be in any sense limiting.

The term ‘comprising’ as used in this specification and claims means ‘consisting at least in part of’, that is to say when interrupting independent claims including that term, the features prefaced by that term in each claim will need to be present but other features can also be present.

### BRIEF DESCRIPTION OF THE DRAWINGS

A preferred embodiment of the invention is described by way of example only, with reference to the drawings, in which:

FIG. 1 shows use of a vehicle carrying the attachment from behind as the vehicle moves forward between rows of fruit trees in an orchard,

FIG. 2 shows a vehicle carrying the attachment in use, from the front,

FIG. 3 is a plan view of the attachment connected to a vehicle,

FIG. 4 is a side view of the attachment connected to a vehicle,

FIG. 5 is an front view of the attachment connected to a vehicle,

FIG. 6 is a perspective view of the attachment when not connected to a vehicle,

FIG. 7 is a perspective view of the attachment connected to a vehicle with the attachment in it's operating position, and

FIG. 8 is a perspective view similar to that of FIG. 7 but with the attachment in it's non-operating position.

### DETAILED DESCRIPTION OF PREFERRED FORM

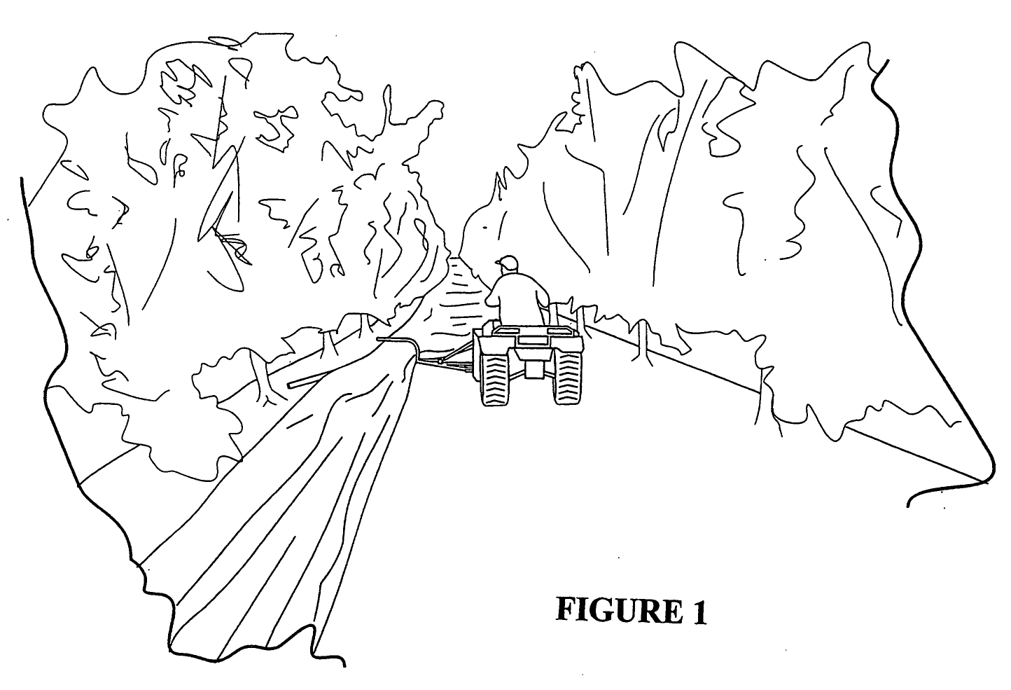

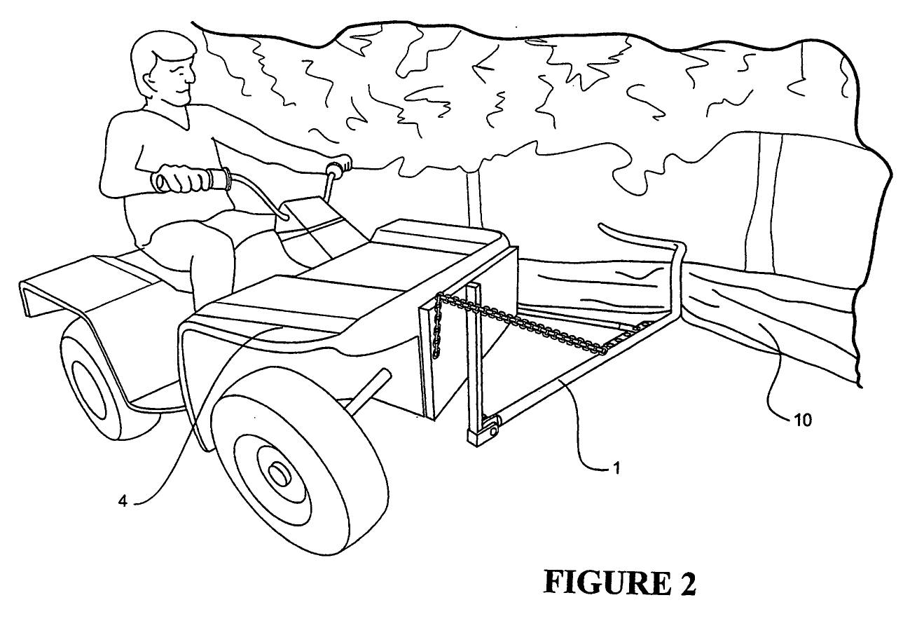

Referring to the drawings, FIGS. 1 and 2 show the preferred form of ground cover removal attachment 1 connected to a quad bike 4 during use for removing to one side, a sheet ground cover 10 previously laid out between rows of trees in an orchard, as the vehicle moves between the rows. As the vehicle moves forward, the attachment operates to lift and push one side of the sheet ground cover towards the other, and in essence to bunch or fold the ground cover out of the way to one side of the aisle between the rows of trees, as a person drives a vehicle such as the quad bike shown, between the rows of trees.

The attachment 1 comprises in the preferred form an arm 2 which connects to the vehicle 4 at one end. The arm when in an operating position, extends outwardly of the vehicle to one side of the vehicle as shown. The other or outer end of the arm is shaped to engage the ground cover on one side of the ground cover and move that side of the ground cover towards the other side of the ground cover.

In use, to push the ground cover to one side, the side margin of the ground cover at one end may be initially manually bunched or folded to one side and fed through the shaped outer end of the attachment, in it's operating position extending to one side of the vehicle. Typically a person is initially required to stand on the bunched or folded portion ground cover at one end or a weight or fastener used to restrict the movement of the bunched or folded portion of the ground cover. The vehicle is then be driven forward along the row as shown in FIGS. 1 & 2, so that the attachment will move the ground cover to one side along it's length.

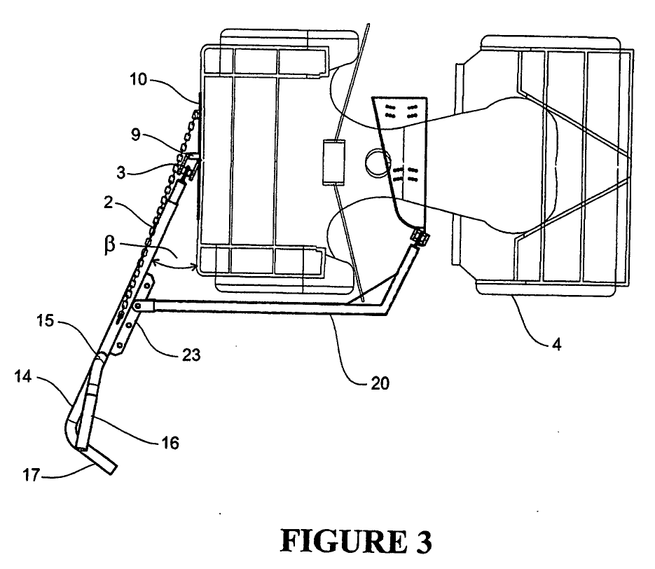

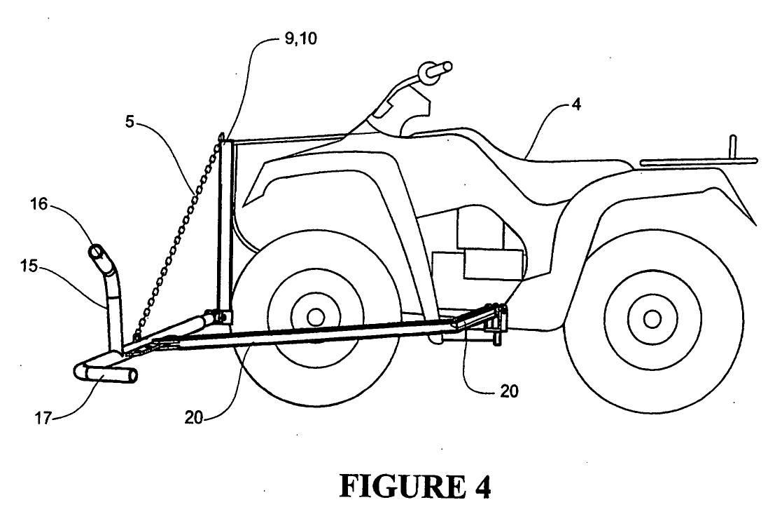

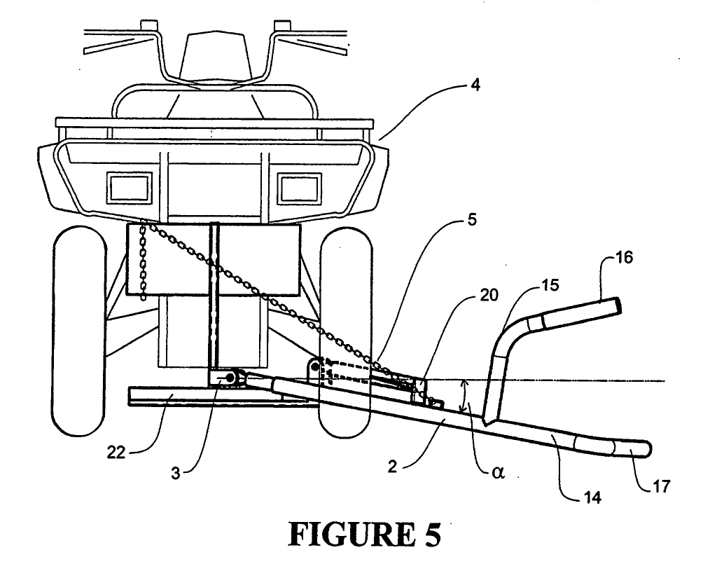

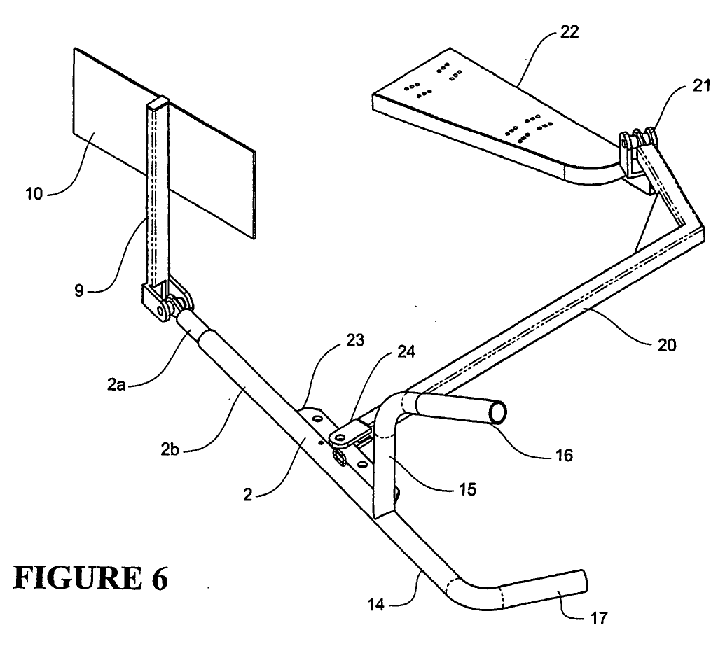

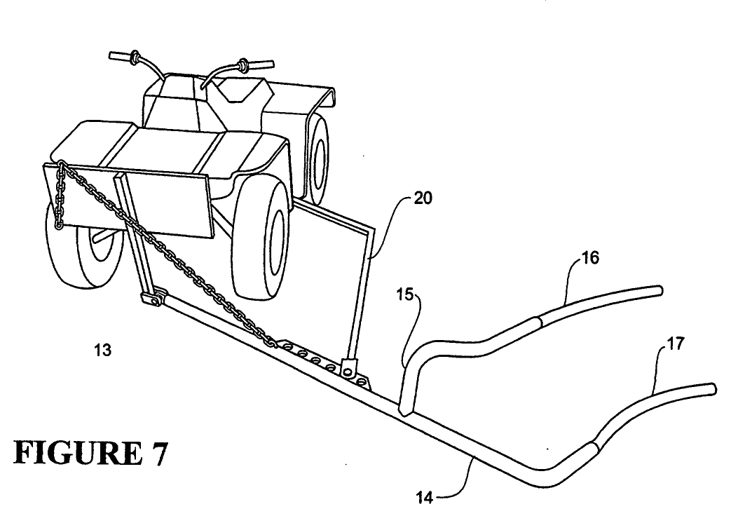

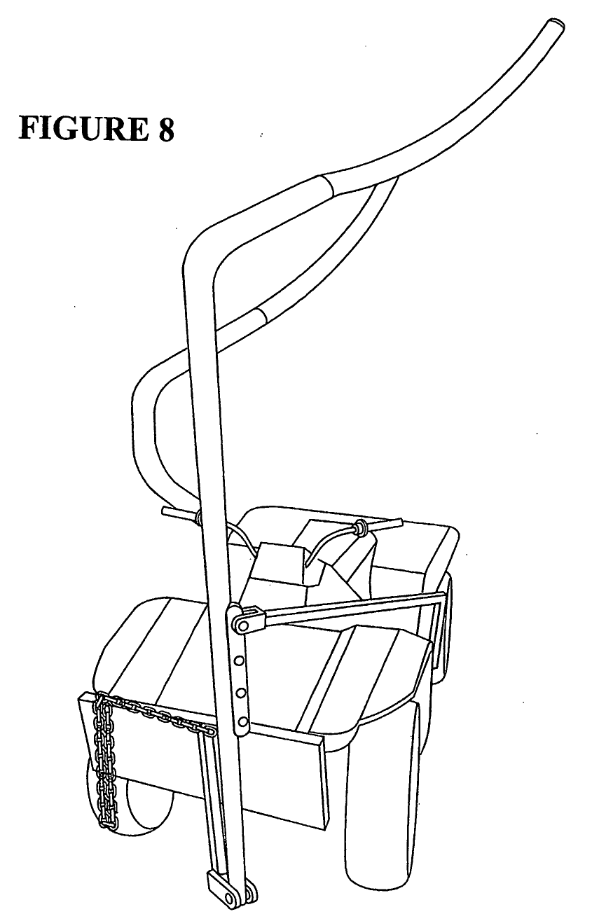

FIG. 3 is a plan view of the preferred form attachment 1 connected to the vehicle, FIG. 4 a side view, FIG. 5 a front view, and FIG. 6 shows the attachment alone. The arm 2 is mounted by a pivot connection 3 to the front of the vehicle, but alternatively could be mounted to the rear or to one side of a vehicle. The pivot connection 3 allows the arm to be pivoted from an operating position as shown in FIGS. 1-7 to an upright, non-operating position as shown in FIG. 8. The attachment includes a chain 15 connected between the arm 2 and the vehicle 4 which tethers the arm and by which the angle of the arm relative to the ground may be adjusted. The claim is adjusted to hold the outer operative end of the arm just above the ground in use. The angle of the arm 2 relative to the ground in use will vary depending upon the height of the pivot connection 3 above the ground, but typically the angle alpha of the arm 2 to the horizontal as indicated in FIG. 5 will be in the range 5-15 degrees. Alternatively however, a wire cable or rope or the like or a rigid length adjustable or fixed length arm may be used to hold the arm 2 in position. In the preferred form, when the attachment is moved to it's non-operating position shown in FIG. 8, the chains is shortened and reconnected to the vehicle to hold the attachment upright. The upright position is used, for example, at the end of each row of ground cover to allow the vehicle to travel without the attachment unintentionally striking objects.

The attachment comprises a generally fork-shaped outer end 6 for lifting and moving the ground cover. Preferably the shaped outer end of the arm comprises one part adapted to slide beneath and lift the side margin of the ground cover as the vehicle moves forward in use, and another generally upright part which engages a side edge of the ground cover. In the preferred form part 14 of the outer end of the arm slides beneath the ground cover, and part 15 extends generally upright as shown, and engages the side edge of the ground cover. The part 15 comprises a further part 16 on the shaped end of the arm which extends from the side engaging part 15 in a direction generally away from the arm as shown. In addition end 17 of part 14 is cranked to form a cranked outer end of the arm.

The arm including the outer end parts 14-17 may for example be formed from metal tubing, with smooth bends to avoid catching the ground cover as the vehicle and attachment move forward. The attachment could alternatively be formed from smoothly folded sheet metal in a monocoque construction for example, to provide an arm with a fork-shaped outer end which can be attached to for example the side of a vehicle, or alternatively again the arm could be moulded from plastics material.

The outer end parts 14-17 of the arm may include a friction reducing cover or coating, such as a coating of a friction reducing plastics material. Where the outer end parts 14-17 are as in the preferred form, formed of metal tubes for example, a tubular plastics pipe may be slid, over the arm parts 14-17. Also, the ends of such plastic tubes may extend beyond the ends of the arm parts 16 and 17, to act as flexible guides for in use guiding the distance between a row of trees and the vehicle.

In the preferred form described the arm is mounted to the front of the quad bike shown. In particular the inner end of the arm 2 is coupled via pivot connection 3 to the lower end of member 9 which is in turn brazed or bolted to plate 10 which sits flat against and is secured to the front of the carry/protective frame on the quad bike. The plate 10 maybe through-bolted to the quad bike frame or coupled to the quad bike frame via mechanical clamps or similar. The vehicle may be other than a quad bike, and may be for example a small four wheel drive vehicle to the front of which the arm is suitably mounted, a towed vehicle or similar. Alternatively, again the arm may be attached to the side of a vehicle or to the rear of a vehicle.

The preferred form attachment further also includes a brace member 20 pivotally connectable to the vehicle at one end and the arm 2 at its other end, to hold the arm 2 in position and to prevent it from being deflected rearwardly as the vehicle moves forward. The brace arm is J-shaped as shown to avoid striking the vehicle as the attachment is moved from the operating position to the upright, non-operating position. The brace member 20 is connected by pivot connection 21 to attachment member 22 which may be bolted to the underside of the vehicle. Rather than being pivotally connected to the vehicle, the arm 4 may be rigidly connected to the vehicle and the brace member 3 may then not be required.

Preferably the pivot connection 3, and brace member 20 (if provided) mount the arm 2 so that it projects forward at a small angle to the vehicle, which in the preferred form shown as the angle beta indicated in FIG. 3, which will typically be in the range 15-25 degrees. Such a slight angle has been found to assist in most effective operation of the attachment for moving a ground cover in use. This angle can be adjusted by shifting the connection point of the brace member 20 to the arm 2.

Referring to FIG. 6 the length of the arm 2 may be telescopically adjustable, comprising two parts 2a and 2b in telescopic relationship to allow for variation in the distance between the vehicle and a row of plants, trees or vines and also variation in the width of ground cover. The length of the arm also determines the distance that the ground cover will be pushed. As the arm is extended, the ground cover is pushed further away from the vehicle. The preferred form arm 2 also 3 includes a flange 23 with spaced holes 24 to allow the position of the coupling 24 between the arm 2 and brace member 3 to be adjusted as the length of the main arm is adjusted.

The foregoing describes the invention including a preferred thereof. Alterations and modifications as will be obvious to those skilled in the art are intended to be incorporated within the scope hereof, as defined in the accompanying claims.

1. A ground cover removal attachment for a vehicle for moving a sheet ground cover while on the ground, comprising an arm with a connection at one end of the arm for mounting the arm to a vehicle so that the arm extends outwardly of one side of the vehicle, and an outer end of the arm shaped to engage the ground cover on one side of the ground cover to move the ground cover to the side of the vehicle as the vehicle moves alongside the ground cover.

2. A ground cover removal attachment according to claim 1 wherein the shaped outer end of the comprises one part adapted to move beneath a side margin of the ground cover and another part adapted to contact a side edge of the ground cover, as the vehicle moves alongside the ground cover.

3. A ground cover removal attachment for a vehicle according to claim 2 wherein the part adapted to move beneath the side margin of the ground cover has a lateral dimension in a direction generally away from the arm which is greater than a height dimension of the part adapted to contact a side edge of the ground cover.

4. A ground cover attachment for a vehicle according to claim 2 wherein a further part of the shaped end of the arm extends from the side edge contacting part in a direction generally away from the arm.

5. A ground cover attachment for a vehicle according to claim 2 wherein the part of the shaped end of the arm adapted to move beneath a side margin of the ground cover includes a cranked outer end.

6. A ground cover removal attachment according to claim 1 wherein the connection for mounting the arm to a vehicle comprises a pivot connection which enables the arm to be pivoted to a non-operating position relative to the vehicle, in which the arm does not extend outwardly of the vehicle.

7. A ground cover removal attachment according to claim 6 including a brace member connected to the arm intermediate of the length thereof at one end of the brace member and connectable to the vehicle at another end of the brace member.

8. A ground cover removal attachment according to claim 7 including a pivot connection at said another end of the brace member for pivotally connecting the brace member to a vehicle.

9. A ground cover removal attachment according to claim 7 wherein the connection point of the brace member to the arm is adjustable over a part of the length of the arm.

10. A ground cover removal attachment according to claim 7 of dimensions enabling the arm to be connected to a quad bike, at a forward part between the front wheels thereof with said another end of the brace arm connected to a side part of the quad bike between the wheels on one side of the quad bike.

11. A ground cover removal attachment according to claim 1 wherein the arm is telescopically adjustable in length.

12. A ground cover removal attachment according to claim 1 including a friction reducing cover or coating on the outer end of the arm.

13. A ground cover removal arm for moving a ground cover with a vehicle to which the arm is attached with the arm extending outwardly of one side of the vehicle, the arm including at one end a coupling for mounting the arm to a vehicle, an outer end formed as a fork for lifting and folding a side of the ground cover as the vehicle moves alongside the ground cover to one side of the ground cover, and a brace member adapted to extend between the arm and the vehicle at a spaced mounting point on the vehicle.

14. A vehicle with a ground cover removal arm according to claim 1 mounted thereto.

15. A vehicle and ground cover removal arm in combination according to claim 14 wherein the arm is mounted to project forwardly relative to the direction of motion of the vehicle in use, at an acute angle relative to a line transverse to the direction of motion of the vehicle in use.

16. A vehicle and ground cover removal arm in combination according to claim 14 wherein the vehicle is a quad bike.

17. A vehicle with an arm extending outwardly of the vehicle to one side thereof beyond that side of the vehicle, and capable of lifting and folding a side of a sheet ground cover to one side as the vehicle moves alongside the ground cover, the arm having spaced outwardly of the side of the vehicle an operative part for lifting and moving the ground cover.

18. A vehicle with an arm extending outwardly of the vehicle to one side thereof according to claim 17 wherein the arm is mounted to project forwardly relative to the direction of motion of the vehicle in use, at an acute angle relative to a line transverse to the direction of motion of the vehicle in use.

19. (canceled)

20. A vehicle and ground cover removal arm in combination according to claim 15 wherein the vehicle is a quad bike.
